(19) United States
(12) Patent Application Publication
(10) Pub. No.: US 2009/0030095 A1
(43) Pub. Date: Jan. 29, 2009

(54) Polystyrene compositions and methods of making and using same

(76) Inventors: Kenneth S. Laverdure, Lake Jackson, TX (US); Robert Dotter, Houston, TX (US)

Correspondence Address: David J. Alexander;Fina Technology, Inc., P.O. Box 674412, Houston, TX, 77267-4412, US

(21) Appl. No.: 11/782,259

(22) Filed: Jul. 24, 2007

(51) Int. Cl. C08J 9/16

(52) U.S. Cl. 521/60

(57) ABSTRACT

Disclosed is a method comprising contacting polystyrene with carbon black and expandable microspheres to form a composition, and expanding the microspheres to foam the composition. Also disclosed is a foamed composition comprising polystyrene, carbon black, and expandable microspheres. The inventive polystyrene compositions have improved mechanical properties.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Technical Field

This disclosure relates to polystyrene compositions. More specifically, this disclosure relates to foamed polystyrene compositions which include carbon black and expandable microspheres and methods of using the polystyrene compositions. The inventive polystyrene compositions have improved mechanical properties.

2. Background

Polystyrene composition, for example foamed polystyrene compositions, are useful in a variety of applications. Foamed polystyrene offers the advantages of low cost and excellent physical properties such as high structural strength and low density. Foamed polystyrene is used to produce a variety of end use products and articles.

One of the problems encountered in the production of foamed polystyrene is that decreasing the density of the material results in a decrease in mechanical properties. For example, while polystyrene foam may replace wood in decorative applications, the materials cannot be used to replace load-bearing lumber as the polystyrene foams have a stiffness and flexural modulus incompatible with these functions. Thus, it would be desirable to develop a polystyrene foam material having improved load-bearing capabilities.

### BRIEF SUMMARY

Disclosed herein is a method comprising contacting polystyrene with carbon black and expandable microspheres to form a composition, and expanding the microspheres to foam the composition.

Also disclosed herein is a foamed composition comprising polystyrene, carbon black, and expandable microspheres.

The foregoing has outlined rather broadly the features and technical advantages of the present disclosure in order that the detailed description of the embodiments that follow may be better understood. Additional features and advantages of the embodiments will be described hereinafter that form the subject of the claims of the disclosure. It should be appreciated by those skilled in the art that the conception and the specific embodiments disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

FIG. 1 is a graph of the flexural modulus as a function of carbon black for the samples from Example 1.

FIG. 2 shows an image of the foamed polystyrene Sample 4 prepared with the chemical blowing agent SAFOAM FP-40.

FIG. 3 shows an image of the foamed polystyrene Sample 7 foamed with 1% EXPANCEL expandable microspheres.

FIG. 4 shows an image of the foamed polystyrene Sample 8 comprising 1% EXPANCEL expandable microspheres and 5% carbon black.

FIG. 5 shows an image of the foamed polystyrene Sample 5 prepared with 1% of the chemical blowing agent SAFOAM FP-40 and 5% carbon black.

FIG. 6 shows an image of the foamed polystyrene Sample 6 prepared with 15% carbon black and 1% SAFOAM FP-40.

FIG. 7 shows an image of the foamed polystyrene Sample 9 prepared with 15% carbon black and 1% EXPANCEL expandable microspheres.

### DETAILED DESCRIPTION

Disclosed herein are foamed polystyrene compositions having improved mechanical properties and methods of making and using same. In an embodiment, the polymeric composition comprises a styrenic polymer, expandable microspheres and carbon black. Such compositions may produce a foamed polystyrene which may display an increased strength as evinced by an increased flexural modulus when compared to polystyrene compositions lacking expandable microspheres and carbon black but having a similar density. These compositions comprising a styrenic polymer, expandable microspheres, and carbon black having been prepared as described herein, will be referred to hereinafter as polystyrene compositions having improved mechanical properties (PSIMPs).

In an embodiment, the PSIMP comprises a styrenic polymer (i.e., polystyrene), wherein the styrenic polymer may be a homopolymer or may optionally comprise one or more comonomers. Styrene, also known as vinyl benzene, ethyenylbenzene and phenylethene is an organic compound represented by the chemical formula C₈H₈. Styrene is widely commercially available and as used herein the term styrene includes a variety of substituted styrenes (e.g., alpha-methyl styrene), ring-substituted styrenes such as p-methylstyrene, disubstituted styrenes such as p-t-butyl styrene as well as unsubstituted styrenes. In an embodiment, the styrenic polymer is present in an amount of from 1.0 to 99.9% weight percent by total weight of the composition (wt. %), alternatively from 5 to 99%, alternatively from 10% to 95%. In an embodiment, the styrenic polymer comprises the balance of the PSIMP when other ingredients are accounted for.

In some embodiments, the styrenic polymer may further comprise a comonomer which when polymerized with the styrene forms a styrenic copolymer. Examples of such comonomers may include for example and without limitation α-methylstyrene; halogenated styrenes; alkylated styrenes; acrylonitrile; esters of (meth)acrylic acid with alcohols having from 1 to 8 carbons; N-vinyl compounds such as vinylcarbazole, maleic anhydride; compounds which contain two polymerizable double bonds such as for example and without limitation divinylbenzene or butanediol diacrylate; or combinations thereof. The comonomer may be present in an amount effective to impart one or more user-desired properties to the composition. Such effective amounts may be determined by one of ordinary skill in the art. For example, the comonomer may be present in the styrenic polymer in an amount ranging from 1 to 99.9% weight percent by total weight of the composition, alternatively from 1 to 90%, alternatively from 1 to 50%.

In some embodiments, the styrenic polymer may further comprise an elastomer, and the resultant composition may be a high impact polystyrene (HIPS). Such HIPS contain an elastomeric phase that is embedded in the polystyrene matrix resulting in the composition having an increased impact resistance. In an embodiment, the styrenic polymer composition is a HIPS comprising a conjugated diene monomer as the elastomer. Examples of suitable conjugated diene monomers include without limitation 1,3-butadiene, 2-methyl-1,3-butadiene, 2 chloro-1,3 butadiene, 2-methyl-1,3-butadiene, and 2 chloro-1,3-butadiene. Alternatively, the HIPS comprises an aliphatic conjugated diene monomer as the elastomer. Without limitation, examples of suitable aliphatic conjugated diene monomers include C₄ to C₉ dienes such as butadiene monomers. Blends or copolymers of the diene monomers may also be used. The elastomer may be present in amounts effective to produce one or more user-desired properties. Such effective amounts may be determined by one of ordinary skill in the art. For example, the elastomer may be present in the styrenic polymer in an amount ranging from 0.1 to 50% weight percent by total weight of the composition, alternatively from 0.5 to 40%, alternatively from 1 to 30%.

In an embodiment, a process for production of the styrenic polymer comprises contacting styrene monomer and other components such as comonomers as known to one of ordinary skill in the art under reaction conditions suitable for the polymerization of the monomer.

In an embodiment, a process for the production of the styrenic polymer comprises contacting the styrenic monomer with at least one initiator. Any initiator capable of free radical formation that facilitates the polymerization of styrene may be employed. Such initiators are well known in the art and include by way of example and without limitation organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides or combinations thereof. The selection of initiator and effective amount will depend on numerous factors (e.g. temperature, reaction time) and can be chosen by one skilled in the art to meet the desired needs of the process. Polymerization initiators and their effective amounts have been described in U.S. Pat. Nos. 6,822,046; 4,861,127; 5,559,162; 4,433,099 and 7,179,873 each of which are incorporated by reference herein in their entirety.

In an embodiment, the polymerization reaction to form the styrenic polymer may be carried out in a solution or mass polymerization process. Mass polymerization, also known as bulk polymerization refers to the polymerization of a monomer in the absence of any medium other than the monomer and a catalyst or polymerization initiator. Solution polymerization refers to a polymerization process in which the monomers and polymerization initiators are dissolved in a non-monomeric liquid solvent at the beginning of the polymerization reaction. The liquid is usually also a solvent for the resulting polymer or copolymer.

The polymerization process can be either batch or continuous. In an embodiment, the polymerization reaction may be carried out using a continuous production process in a polymerization apparatus comprising a single reactor or a plurality of reactors. For example, the polymeric composition can be prepared using an upflow reactor. Reactors and conditions for the production of a polymeric composition are disclosed in U.S. Pat. No. 4,777,210, which is incorporated by reference herein in its entirety.

The temperature ranges useful with the process of the present disclosure can be selected to be consistent with the operational characteristics of the equipment used to perform the polymerization. In one embodiment, the temperature range for the polymerization can be from 90° C. to 240° C. In another embodiment, the temperature range for the polymerization can be from 100° C. to 180° C. In yet another embodiment, the polymerization reaction may be carried out in a plurality of reactors with each reactor having an optimum temperature range. For example, the polymerization reaction may be carried out in a reactor system employing a first and second polymerization reactors that are either continuously stirred tank reactors (CSTR) or plug-flow reactors. In an embodiment, a polymerization reactor for the production of a styrenic polymer of the type disclosed herein comprising a plurality of reactors may have the first reactor (e.g. a CSTR), also known as the prepolymerization reactor, operated in the temperature range of from 90C. to 135° C. while the second reactor (e.g. CSTR or plug flow) may be operated in the range of from 100° C. to 165° C.

The polymerized product effluent from the first reactor may be referred to herein as the prepolymer. When the prepolymer reaches the desired conversion, it may be passed through a heating device into a second reactor for further polymerization. The polymerized product effluent from the second reactor may be further processed as is known to one of ordinary skill in the art and described in detail in the literature. Upon completion of the polymerization reaction, a styrenic polymer is recovered and subsequently processed, for example devolatized, pelletized, etc.

In an embodiment, the styrenic polymer may also comprise additives as deemed necessary to impart desired physical properties, such as, increased gloss or color. Examples of additives include without limitation chain transfer agents, talc, antioxidants, UV stabilizers, lubricants, mineral oil, plasticizers and the like. The aforementioned additives may be used either singularly or in combination to form various formulations of the composition. For example, stabilizers or stabilization agents may be employed to help protect the polymeric composition from degradation due to exposure to excessive temperatures and/or ultraviolet light. These additives may be included in amounts effective to impart the desired properties. Effective additive amounts and processes for inclusion of these additives to polymeric compositions are known to one skilled in the art. For example, one or more additives may be added after recovery of the styrenic polymer, for example during compounding such as pelletization. Alternatively or additionally to the inclusion of such additives in the styrenic polymer component of the PSIMPs, such additives may be added during formation of the PSIMPS or to one or more other components of the PSMIPs.

In an embodiment, the PSIMP comprises microspheres, alternatively expandable microspheres. Herein an expandable microsphere refers to a material comprising an expandable shell encapsulating an expandable material. In an embodiment, an expandable microsphere comprises a thermoplastic polymer shell encapsulating a hydrocarbon gas. When heated, the thermoplastic shell encapsulating the hydrocarbon gas softens. Concurrent with the softening of the thermoplastic shell, the gas expands and exerts an increasing pressure on the shell resulting in an increase in the volume of the microspheres. When fully expanded, the volume of the microspheres may increase to more than 40 times its original volume. Examples of expandable microspheres suitable for use in this disclosure include without limitation EXPANCEL WU, EXPANCEL DU, EXPANCEL SL and EXPANCEL MB which are expandable microspheres commercially available from Expancel an Akzo Nobel company and ADVANCELL EM which are expandable microspheres commercially available from Sekisui Chemical Company. Other expandable microspheres that are commercially available or known to one skilled in the art are also suitable for use in this invention. In an embodiment, the expandable microspheres are present in the PSIMP in an amount of from 0.1 wt. % to 50 wt. %, alternatively from 0.1 wt. % to 10 wt. %, alternatively from 1 wt. % to 9 wt. % wherein the weight percent is based on the total weight of the composition.

In an embodiment, the PSIMP is further comprised of carbon black. Carbon black [C.A.S No. 1333-86-4] is virtually pure elemental carbon in the form of colloidal particles. The majority of carbon black is produced using manufacturing processes termed furnace black and thermal black. In addition to the differences in the types of reactors used, the thermal black and furnace black processes differ in the nature of the primary feedstock employed. Specifically, the furnace black process uses heavy aromatic oils as the feedstock while the thermal black process relies on natural gas comprising methane or heavy aromatic oils as the feedstock. Without wishing to be limited by theory, carbon black may function as a reinforcing agent in the polymeric composition resulting in the material having an increased structural integrity. Carbon black is widely commercially available and may be included in the PSIMP in amounts ranging from 0.1 wt. % to 13 wt. %, alternatively from 1 wt. % to 10 wt. %, alternatively from 3 wt. % to 8 wt. % wherein the weight percent is based on the total weight of the composition.

In an embodiment, the PSIMP is prepared by contacting the styrenic polymer with carbon black and expandable microspheres, and thoroughly mixing the components for example by compounding or extrusion. In an embodiment, the styrenic polymer is plasticized or melted by heating in an extruder and is contacted and mixed thoroughly with the carbon black and expandable microspheres at a temperature less than 350° F. Alternatively, the styrenic polymer may be contacted with the carbon black and expandable microspheres prior to introduction of the mixture to the extruder (e.g., via bulk mixing), during the introduction of the styrenic polymer to an extruder or combinations thereof.

The expandable microspheres may be expanded to foam the composition. For example, the microspheres may be expanded by heating the microspheres and/or reducing the pressure of the composition such as occurs when the molten composition exits the extruder and enters a die, mold, or other shaping process. Without wishing to be limited by theory, the thermoplastic shell of the expandable microsphere softens during extrusion and the expandable material expands due to temperature increase and/or pressure drop, which forces the walls of the thermoplastic shell to physically contact the molten styrenic polymer and carbon black, thereby foaming the PSIMP. In an embodiment, the foamed PSIMPs composition may then pass through a relaxation zone, in the last stage of extruder prior to being introduced to the die, in which it is cooled. The PSIMP may be cooled from a temperature ranging from 150° C. to 210° C. to a temperature ranging from 40° C. to 100° C. with continuous stirring before being extruded through a die. The thermoplastic shell of the expandable microspheres may harden upon cooling to allow the microspheres to maintain their expanded volume. Methods for preparing a foamed polystyrene composition are described in U.S. Pat. Nos. 5,006,566 and 6,387,968 each of which are incorporated by reference herein in its entirety.

Without wishing to be limited by theory, the use of a chemical foaming agent, also known as a chemical blowing agent, generates gases which become entrained in the composition. The gases generated in turn may generate voids within the material thus reducing the structural integrity of the material when compared to a material foamed with expandable microspheres (i.e. PSIMPs). The expandable microspheres act as physical blowing agents which retain a thermoplastic shell after serving as a foaming agent resulting in a reduced amount of void space forming in the foamed material. Furthermore, carbon black when added to the material containing the chemical blowing agent may react with gas(es) created by the blowing agent and further reduce the structural integrity of the material. However, when utilizing expandable microspheres, the gas formed is encapsulated and not available to react with the carbon black thus, the structural integrity of the material may be increased by the presence of both carbon black and the expandable microspheres.

The PSIMPS of this disclosure may be converted to end-use articles by any suitable method. The end use articles may be produced about concurrently with the mixing and/or foaming of the PSIMPS (e.g., on a sequential, integrated process line) or may be produced subsequent to mixing and/or foaming of the PSIMPS (e.g., on a separate process line such as an end use compounding and/or thermoforming line). In an embodiment, the PSIMP is mixed and foamed via extrusion or compounding as described herein, and the molten PSIMP is fed to a shaping process (e.g., mold, die, lay down bar, etc.) where the PSIMP is shaped. The foaming of the PSIMP may occur prior to, during, or subsequent to the shaping. In an embodiment, molten PSIMP is injected into a mold, where the PSIMP undergoes foaming and fills the mold to form a shaped article. In an embodiment, the PSIMP is formed into a sheet, which is then subjected to further processing steps such as thermoforming to produce an end-use article. Examples of end use articles into which the PSIMPS may be formed include food packaging; office supplies; plastic lumber or replacement lumber; patio decking; structural supports; laminate flooring compositions; polymeric foam substrate and decorative surfaces such as crown molding; weatherable outdoor materials; point-of-purchase signs and displays; housewares and consumer goods; building insulation; cosmetics packaging; outdoor replacement materials; and so forth. Additional end use articles would be apparent to those skilled in the art.

In an embodiment, the PSIMPs may display enhanced mechanical properties such as an increased stiffness as reflected in an increased flexural modulus. Herein the flexural modulus of a material is an indicator of the material's ability to resist deformation under load. The flexural modulus test in broad terms measures the force required to bend a sample material beam. Specifically, a force is applied to the center of the sample beam, while the beam is supported on both ends. In an embodiment, the PSIMPs prepared as disclosed herein have a flexural modulus of from 1,000 psi to 10,000,000 psi, alternatively from 10,000 psi to 1,000,000 psi, alternatively from 100,000 psi to 500,000 psi, as measured according to ASTM D-790 or ISO 178. The flexural modulus of a PSIMPs comprising expandable microspheres and carbon black may be increased by greater than 20%, alternatively greater than 30%, alternatively greater than 35% when compared to an otherwise identical foamed composition having a similar density but using a chemical blowing agent rather than expandable microspheres.

### EXAMPLES

The embodiments having been generally described, the following examples are given as particular embodiments of the disclosure and to demonstrate the practice and advantages thereof. It is understood that the examples are given by way of illustration and are not intended to limit the specification of the claims in any manner.

### Example 1

The use of expandable microspheres and carbon black to increase the flexural modulus of a polystyrene composition was investigated. Specifically, polystyrene foam compositions comprising a blowing agent (i.e., SAFOAM FP-40 or EXPANCEL 950 MB 120), and carbon black in the amounts indicated in Table 1 were prepared. The base resin used for each sample was POLYSTYRENE 585 which is a high molecular weight low melt flow crystalline polystyrene commercially available from Total Petrochemicals. The typical physical properties of POLYSTYRENE 585 are given in Table 2. SAFOAM FP-40 is an endothermic chemical nucleating and blowing agent commercially available from Reedy International. Sheets of a 20-mil (starting) gauge were produced for each sample composition on a WELEX minisheet line according to the processing conditions given in Table 1.

TABLE 1

| | | Sample | | | | | | | | |
|---|---|---|---|---|---|---|---|---|---|---|
| | Unit | 1 | 2 | 3 | 4 | 5 | 6 | 7 | 8 | 9 |
| % SAFOAM FP-40 | | 0% | 0% | 0% | 1% | 1% | 1% | 0% | 0% | 0% |
| % EXPANCEL | | 0% | 0% | 0% | 0% | 0% | 0% | 1% | 1% | 1% |
| % Carbon Black | | 0% | 5% | 15% | 0% | 5% | 15% | 0% | 5% | 15% |
| Zone 1 | ° F. | 370 | 370 | 370 | 370 | 370 | 370 | 370 | 370 | 370 |
| Zone 2 | ° F. | 395 | 395 | 395 | 395 | 395 | 395 | 395 | 395 | 395 |
| Zone 3 | ° F. | 405 | 405 | 405 | 405 | 405 | 405 | 405 | 405 | 405 |
| Die 1 | ° | 405 | 405 | 405 | 405 | 405 | 405 | 405 | 405 | 405 |
| Die 2 | ° F. | 410 | 410 | 410 | 410 | 410 | 410 | 410 | 410 | 410 |
| Melt Temp. | ° F. | 423 | 423 | 423 | 423 | 423 | 423 | 422 | 423 | 423 |
| Motor Power | Amps | 13 | 12 | 12 | 12 | 12 | 11 | 10 | 12 | 11 |
| Screw Speed | RPM | 100 | 100 | 100 | 100 | 100 | 100 | 100 | 100 | 100 |
| Pressure Ext. | PSI | 2000 | 1900 | 1900 | 1900 | 1950 | 1900 | 2000 | 2000 | 1900 |
| Pressure Die | PSI | 1500 | 1400 | 1400 | 1400 | 1450 | 1400 | 1500 | 1500 | 1400 |
| Middle Chill Roll | ° F. | 210 | 210 | 210 | 210 | 210 | 210 | 210 | 210 | 210 |
| Bottom Chill Roll | ° F. | 215 | 215 | 215 | 215 | 215 | 215 | 215 | 215 | 215 |
| Take-up Speed | Ft/Min. | 6.25 | 6.25 | 6.25 | 6.25 | 6.25 | 6.25 | 6.25 | 6.25 | 6.25 |

TABLE 2

| | |
|---|---|
| Typical Values | ASTM Test |

Melt Flow

| | | |
|---|---|---|
| Flow gm/10 min,., 200/5.0 | 1.6 | D-1238 |

Tensile Properties

| | | |
|---|---|---|
| Strength, psi | 7,600 | D-638 |
| Modulus, psi (10⁵) | 4.3 | D-638 |

Flexural Properties

| | | |
|---|---|---|
| Strength, psi | 14,200 | D-790 |
| Modulus, psi (10⁵) | 4.3 | D-790 |

Thermal Properties

| | | |
|---|---|---|
| Heat Distortion, ° F. | 212 | D-648 |
| Annealed | | |
| Vicat Softening, ° F. | 224 | D-1525 |

Following the addition of the blowing agent, the sheet was allowed to foam to its natural gauge. The density of each sheet was determined in accordance with ASTM D 1622 with the following exceptions: samples were taken as an 85 mm by 85 mm by natural gauge of foam and the density was measured with the skins present for an apparent density. The flexural modulus of the sheet was measured in both the machine direction (MD) and transverse direction (TD) in accordance with ASTM D-790. Both values, along with the average of these values for each sample, are presented in Table 3.

TABLE 3

| | | Sample | | | | | | | | |
|---|---|---|---|---|---|---|---|---|---|---|
| | | 1 | 2 | 3 | 4 | 5 | 6 | 7 | 8 | 9 |
| MD Flex | kPSI | 880 | 848 | 819 | 405 | 438 | 278 | 430 | 521 | 344 |
| TD Flex | kPSI | 825 | 730 | 970 | 375 | 259 | 195 | 341 | 540 | 244 |
| Ave. Flex | kPSI | 852 | 789 | 895 | 390 | 349 | 237 | 386 | 531 | 294 |
| Sheet Density | g/cc | 1.051 | 1.057 | 1.042 | 0.662 | 0.666 | 0.660 | 0.662 | 0.655 | 0.606 |
| Density Reduction | | 0% | 0% | 0% | 37% | 37% | 37% | 37% | 38% | 42% |

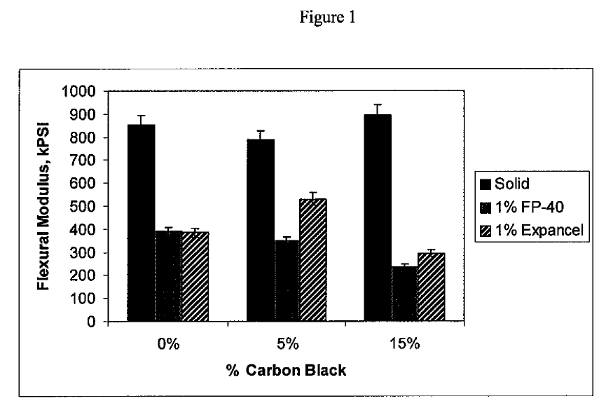

A plot of the flexural modulus as a function of carbon black loading is presented in FIG. 1. The solid sheet in the absence of any blowing agent showed a slightly lower flexural modulus at 5% carbon black (Sample 2) relative to at 15% carbon black (Sample 3) and the control (Sample 1), while the flexural modulus of the foams with the chemical blowing agent steadily decreased with the increasing carbon black concentrations (Samples 4 to 6). The 1% EXPANCEL with 5% carbon black (Sample 8) showed an approximately 35% increase in flexural modulus over the foam with no carbon black (Sample 4 or 7). In the presence of carbon black, the EXPANCEL foams had a higher flexural modulus than the foams containing SAFOAM FP-40. Without carbon black, both blowing agents resulted in the same flexural modulus. The results demonstrate that foamed polystyrene samples having a combination of carbon black and expandable microspheres displayed an increase in the average flexural modulus.

### Example 2

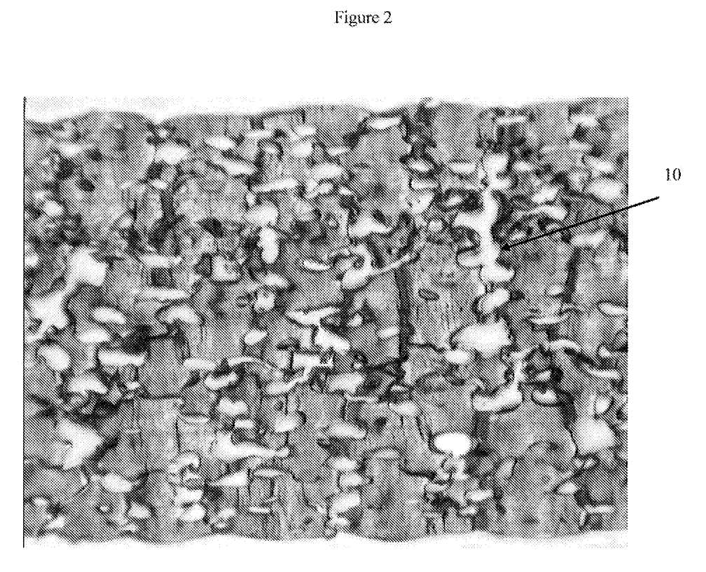

Cross sectional images of Samples 4-9 from Example 1 were prepared using optical microscopy (OM) and are shown in FIGS. 2 through 7. Samples 4-9 comprise POLYSTRENE 585 as the base resin, SAFOAM FP-40, EXPANCEL and carbon black in the amounts indicated in Table 4.

TABLE 4

Sample No.

| | 4 | 5 | 6 | 7 | 8 | 9 |
|---|---|---|---|---|---|---|
| SAFOAM FP-40 | 1% | 1% | 1 | 0 | 0 | 0 |
| EXPANCEL | 0 | 0% | 0% | 1% | 1% | 1 |
| CARBON BLACK | 0 | 5 | 15% | 0 | 5% | 15% |

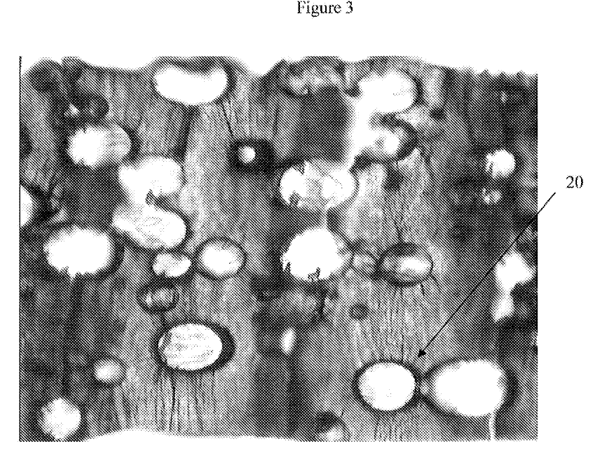

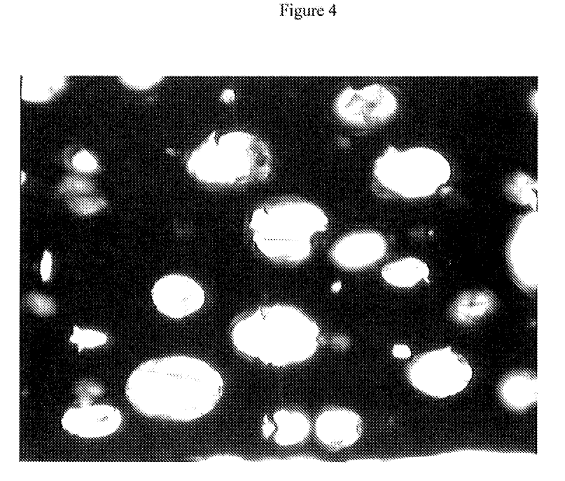

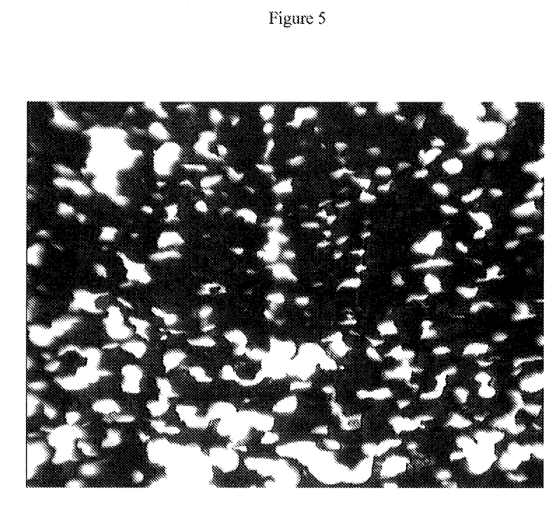

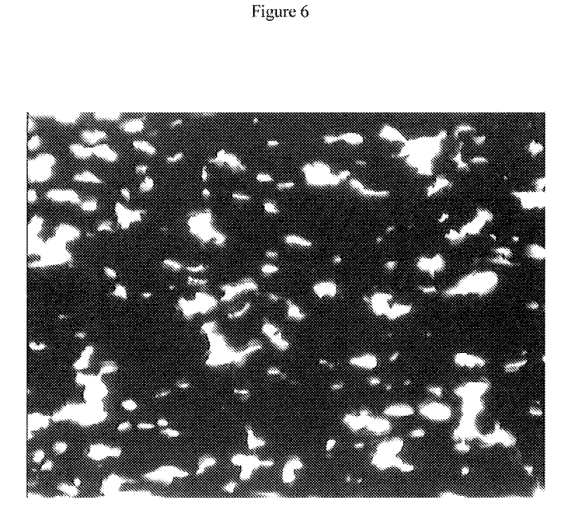

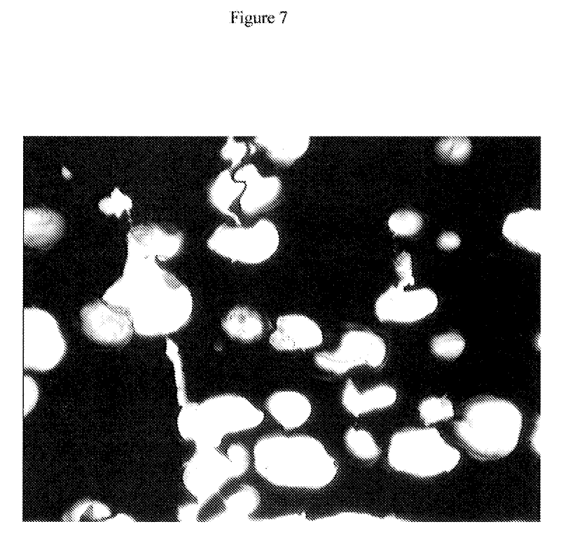

FIG. 2 shows an image of the foamed polystyrene Sample 4 prepared with the chemical blowing agent SAFOAM FP-40. Referring to FIG. 2, the image shows a number of porous interconnecting channels traversing the material. One such channel is indicated by reference arrow 10. Without wishing to be limited by theory, the formation of these channels in the foamed polystyrene is attributed to the action of the chemical blowing agent, SAFOAM FP-40. FIG. 3 shows an image of the same polystyrene base resin foamed with 1% EXPANCEL expandable microspheres, Sample 7. The material has the EXPANCEL expandable microspheres dispersed throughout however, unlike the foamed polystyrene produced with the chemical blowing agent, the microspheres do not substantively connect to form channels in the material. Referring to FIG. 3, there is some interconnectivity observed between the EXPANCEL microspheres as shown by reference arrow 20 but this is much less than what was observed with the chemical blowing agent. FIG. 4 shows an image of the foamed polystyrene comprising 1% EXPANCEL and 5% carbon black, Sample 8. The foamed polystyrene again shows the EXPANCEL microspheres at discrete locations dispersed throughout the material however, there appears to be almost no interconnectivity between the microspheres. A material prepared with the 1% of the chemical blowing agent SAFOAM FP-40 and 5% carbon black shows the formation of interconnected channels throughout the material, FIG. 5 Sample 5, similar to what was observed with the chemical blowing agent in the absence of carbon black, FIG. 2. Increasing the amount of carbon black to 15% in the presence of 1% SAFOAM FP-40 appeared to reduce the interconnectivity of the channels, FIG. 6 Sample 6, however large channels with some interconnectivity are still observed in the material. FIG. 7 shows an image of a foamed polystyrene prepared with 15% carbon black and 1% EXPANCEL expandable microspheres, Sample 9. The results demonstrate that in the presence of less than 15% carbon black and 1% EXPANCEL, the polystyrene foamed material forms a structure that appears to comprise discrete expandable microspheres having little interconnectivity, see FIG. 4, whereas the chemical foaming agent forms porous interconnected channels throughout the material in the presence or absence of carbon black. Increasing the percentage of carbon black to 15% in the presence of 1% EXPANCEL results in an increase in the interconnectivity between the microspheres. Without wishing to be limited by theory the porous interconnected channels formed using the chemical reducing agent may reduce the structural integrity of the foamed polystyrene when compared to the foamed polystyrene prepared with carbon black and the expandable microspheres.

While various embodiments have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of making polystyrene, comprising:
contacting polystyrene with carbon black and expandable microspheres to form a composition; and
expanding the microspheres to foam the composition.

2. The method of claim 1 wherein the contacting and the expanding occur during extrusion or compounding.

3. The method of claim 1 further comprising shaping the foamed composition into an article.

4. The method of claim 1 further comprising forming the foamed composition into a sheet and thermoforming the sheet into an article.

5. The method of claim 1 wherein the polystyrene is a copolymer.

6. The method of claim 1 wherein the polystyrene is a high impact polystyrene.

7. The method of claim 1 wherein the expandable microspheres are present in an amount of from 0.1 wt. % to 50 wt. % based on the total weight of the composition.

8. The method of claim 1 wherein the carbon black is present in an amount of from 0.1 wt. % to 13 wt. % based on the total weight of the composition.

9. The method of claim 3 wherein the article has a greater flexural modulus than an otherwise identical foamed composition and article produced using a chemical blowing agent in place of the expandable microspheres.

10. The method of claim 4 wherein the sheet material has a flexural modulus increase of 20% greater than an otherwise identical foamed composition and article produced using a chemical blowing agent in place of the expandable microspheres.

11. A foamed composition comprising polystyrene, carbon black, and expandable microspheres.

12. The composition of claim 11 wherein the polystyrene is a copolymer.

13. The composition of claim 11 wherein the polystyrene comprises an elastomer.

14. The composition of claim 13 wherein the elastomer comprises a conjugated diene.

15. The composition of claim 11 wherein the carbon black is present in an amount of from 0.1 wt. % to 13 wt. % based on the total weight of the composition.

16. The composition of claim 11 wherein the expandable microspheres are present in an amount of from 0.1 wt. % to 50 wt. % based on the total weight of the composition.

17. An article comprised of the composition of claim 11.

18. The article of claim 17 comprising food packaging; office supplies; plastic lumber or replacement lumber; patio decking; structural supports; laminate flooring compositions; polymeric foam substrate and decorative surfaces; weatherable outdoor materials; point-of-purchase signs and displays; housewares and consumer goods; building insulation; cosmetics packaging; and outdoor replacement materials.

19. The article of claim 17 having a flexural modulus of from 1,000 psi to 10,000,000 psi.

20. The article of claim 17 having a flexural modulus at least 20% greater than an otherwise identical foamed composition and article produced using a chemical blowing agent in place of the expandable microspheres.
